(19) United States
(12) Patent Application Publication
(10) Pub. No.: US 2018/0004388 A1
(43) Pub. Date: Jan. 4, 2018

(54) INFORMATION PROCESSING APPARATUS AND CONTROL METHOD FOR INFORMATION PROCESSING APPARATUS

(71) Applicant: Sharp Kabushiki Kaisha, Sakai City, Osaka (JP)

(72) Inventors: KAZUKI MORIMOTO, Sakai City (JP); KIYOYUKI MIYAZAWA, Sakai City (JP); YUHSUKE HIRANO, Sakai City (JP)

(21) Appl. No.: 15/543,716

(22) PCT Filed: Jan. 13, 2016
(86) PCT No.: PCT/JP2016/050790

§ 371 Date: Jul. 14, 2017

(30) Foreign Application Priority Data
Jan. 15, 2015 (JP) 2015-006036

(51) Int. Cl. G06F 3/0488; G06F 3/0485; G06F 3/041

(52) U.S. Cl. CPC G06F 3/0488; G06F 3/0416; G06F 3/0485

(57) ABSTRACT

A shift from a scroll mode to a pointer mode is more securely caused with a simple operation. A mobile phone (10) includes: a display section (14); a touch pad (16) having a detection region at a location outside a display region, an event identifying section (21) configured to identify a type of a touch event based on location information received from the touch pad (16); and a mode switching section (23) configured to switch a scroll mode, in which a screen is scrollable, to a pointer mode, in which a displayed object is selectable, in a case where a single tap is inputted in the scroll mode.

### TECHNICAL FIELD

The present invention relates to (i) an information processing device which includes (a) a display section and (b) an object detecting section which has, at a location outside a display region of the display section, a planar detection region in which the object detecting section detects an object in proximity to or in contact with the detection region, (ii) a method of controlling the information processing device, and (iii) a control program for the information processing device.

### BACKGROUND ART

As a conventional technique, there has been known an information processing device, such as a mobile phone, which includes a pointing device such as a touch pad or a touch panel. For example, Patent Literature 1 discloses a mobile PC which includes a touch panel.

In the mobile PC disclosed in Patent Literature 1, a user can select a displayed object by making a single tap on a touch panel. In order for the user to more easily carry out an operation of selecting a displayed object, the mobile PC operates in (i) a pointer mode in which a pointer is displayed so as to make a displayed object selectable and (ii) a scroll mode in which a displayed image is scrollable.

### CITATION LIST

### Patent Literature

### Patent Literature 1

Japanese Patent Application Publication Tokukai No. 2011-170901 (Publication date: Sep. 1, 2011)

### SUMMARY OF INVENTION

### Technical Problem

The mobile PC disclosed in Patent Literature 1, however, shifts from the scroll mode to the pointer mode in response to a long tap which is made on the touch panel. This may cause a case where (i) a location of a finger moves while the user is making a long touch on the touch panel and (ii) the long touch is erroneously recognized as a swipe or a flick. That is, there is a problem that the user may fail to shift a mode of the mobile PC.

The present invention has been attained in view of the above problem, and an objective of the present invention is to provide (i) an information processing device which makes it possible to more securely cause a shift from a scroll mode to a pointer mode with a simple operation, (ii) a method of controlling the information processing device, and (iii) a control program for the information processing device.

### Solution to Problem

In order to attain the above objective, an information processing device in accordance with an aspect of the present invention includes: a display section; an object detecting section having, at a location outside a display region of the display section, a planar detection region in which the object detecting section detects an object in proximity to or in contact with the detection region; a location information acquiring section configured to acquire location information indicative of a location where the object detecting section has detected the object; a user's operation identifying section configured to identify a type of a user's operation based on the location information which the location information acquiring section has acquired; and a mode switching section configured to switch a scroll mode, in which a screen is scrollable, to a pointer mode, in which a displayed object is selectable, in a case where the user's operation identifying section identifies a single tap in the scroll mode.

In order to attain the above objective, a method of controlling an information processing device in accordance with an aspect of the present invention is a method of controlling an information processing device which includes a display section, an object detecting section having, at a location outside a display region of the display section, a planar detection region in which the object detecting section detects an object in proximity to or in contact with the detection region, and a location information acquiring section configured to acquire location information indicative of a location where the object detecting section has detected the object, the method including the steps of: (a) identifying a type of a user's operation based on the location information which the Location information acquiring section has acquired; and (b) switching a scroll mode, in which a screen is scrollable, to a pointer mode, in which a displayed object is selectable, in a case where a single tap is identified in the step (a) in the scroll mode.

### Advantageous Effects of Invention

An aspect of the present invention makes it possible to more securely cause a shift from a scroll mode to a pointer mode with a simple operation.

### BRIEF DESCRIPTION OF DRAWINGS

FIG. 1 is a block diagram illustrating a configuration of a main part of a mobile phone in accordance with Embodiment 1 of the present invention.

FIG. 2 is a view illustrating an appearance of the mobile phone.

FIG. 3 is a view illustrating an appearance of the mobile phone which is shifting from a scroll mode to a pointer mode.

FIG. 4 is a flowchart illustrating an example of a process to be carried out while the mobile phone is in the scroll mode.

FIG. 5 is a view illustrating an appearance of a laptop PC in accordance with Embodiment 2 of the present invention.

FIG. 6 is a block diagram illustrating a configuration of a main part of the laptop PC.

FIG. 7 is a flowchart illustrating an example of a process to be carried out while the laptop PC is in a scroll mode.

### DESCRIPTION OF EMBODIMENTS

### Embodiment 1

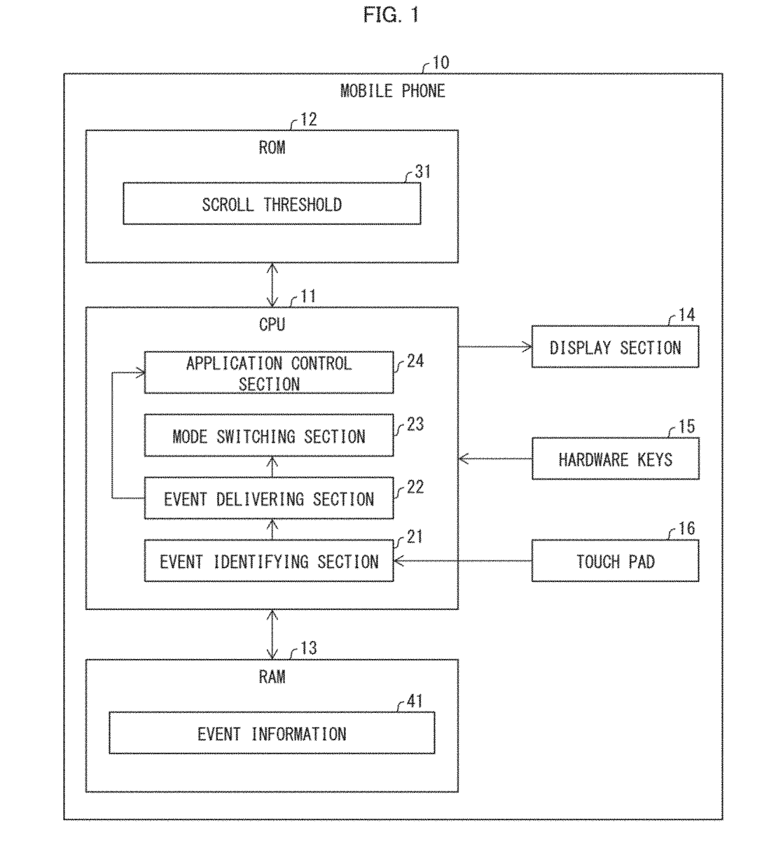

The following description will discuss Embodiment 1 of the present invention with reference to FIGS. 1 through 4.

### Outline of Mobile Phone

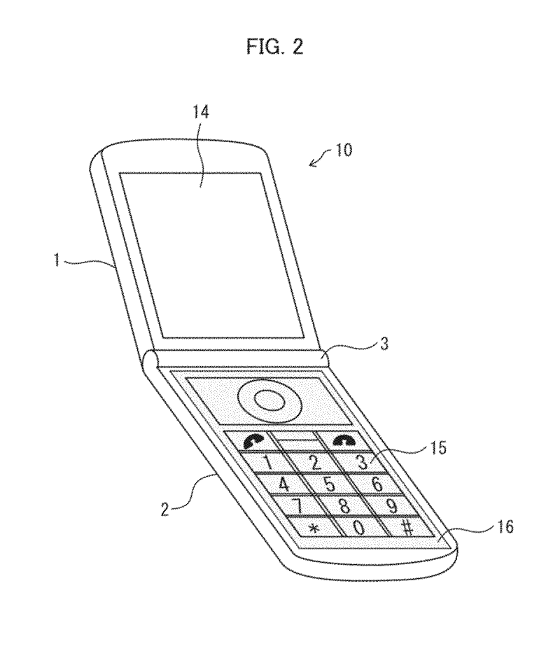

A mobile phone in accordance with Embodiment 1 will be discussed below with reference to FIG. 2. FIG. 2 is a view illustrating an appearance of a mobile phone 10 in accordance with Embodiment 1.

The mobile phone 10 is a so-called foldable mobile phone FIG. 2). The mobile phone 10 includes a first housing 1 and a second housing 2, which are connected to each other via a hinge 3 so as to be rotatable about an axis of the hinge 3. Each of the first housing 1 and the second housing 2 has, for example, a substantially-plate-like shape. The first housing 1 is provided with a display section 14 on a surface of the first housing 1. The second housing 2 is provided with hardware keys 15 on a surface of the second housing 2, and a sensor of a touch pad (object detecting section) 16 beneath the hardware keys 15 (i.e., inside the second housing 2). The sensor of the touch pad 16 is provided so as to overlap with the hardware keys 15.

The mobile phone 10 can change in form between (i) an open state in which the first housing 1 and the second housing 2 are open as illustrated in FIG. 2 and (ii) a closed state (not illustrated) in which (a) the surface (display surface) of the first housing 1, on which surface the display section 14 is provided, and (b) the surface (operation surface) of the second housing 2, on which surface the hardware keys 15 are provided, face each other.

The display section 14 is configured to display an image. The display section 14 can be, for example, a liquid crystal display (LCD) or an organic EL display.

The hardware keys 15 allow a user to operate the mobile phone 10. The hardware keys 15 are physical keys configured to output a signal corresponding to a key which the user has pressed. The hardware keys 15 are made up of, for example, a menu key, numeric keys, an arrow key, a center key, an on-hook key, and an off-hook key.

The touch pad 16 is used to operate the mobile phone 10. The touch pad 16 includes a sensor so as to detect, at given time intervals, an object (e.g., a user's finger or a stylus) in proximity to or in contact with the touch pad 16. The touch pad 16 then outputs location information indicative of a location (e.g., two-dimensional coordinates on the touch pad 16) at which the object has been detected. A detection region, in which the touch pad 16 detects an object, is an entire surface (operation surface) region of the second housing 2 on which surface the hardware keys 15 are provided. That is, the operation surface of the second housing 2 is a detection surface of the touch pad 16. It follows that top surfaces of the respective hardware keys 15 constitute a part of the detection surface and are within the detection region. The sensor included in the touch pad 16 is, for example, a capacitance sensor.

In Embodiment 1, the touch pad 16 detects whether a user's finger is in contact with the operation surface of the second housing 2. The operation surface of the second housing 2 (i.e., the detection region of the touch pad 16) is provided at a location outside a display surface (display region) of the display section 14 (see FIG. 2).

Though FIG. 2 illustrates a foldable mobile phone 10, the mobile phone of Embodiment 1 is not limited thereto. The mobile phone of Embodiment 1 can alternatively be, for example, a bar mobile phone, a slider mobile phone, or a biaxial hinge mobile phone. Though Embodiment 1 is exemplified by a mobile phone, an embodiment of the present invention is not limited to mobile phones. The present invention is applicable to any information processing device that includes (i) a display section and (ii) an object detecting section having, at a location outside a display region of the display section, a planar detection region in which the object detecting section detects an object in proximity to or in contact with the planar detection region. Examples of such an information processing device to which the present invention is applicable include a laptop PC, a portable game device, a digital camera, a digital video camera, and a portable music player.

### Operation Scheme of Mobile Phone

As described above, the mobile phone 10 includes two operation sections (input sections), i.e., the hardware keys 15 and the touch pad 16. In order for a user to easily operate the touch pad 16 (i.e., for the purpose of preventing erroneous operations), the mobile phone 10 operates in three modes, i.e., in a “key operation mode”, a “pointer mode”, and a “scroll mode”.

The key operation mode is a mode in which the mobile phone 10 can be operated only via the hardware keys 15. That is, any operation made via the touch pad 16 is invalid in the key operation mode. In the key operation mode, for example, a user can (i) move a focus (i.e., select an item in a list) by operating a cross key, (ii) enter a decision by pressing a center key, (iii) input numbers and/or characters by operating numeric keys, (iv) start a phone call by pressing an off-hook key, and (v) terminate a phone call or an application by pressing an on-hook key.

The mobile phone 10 in the key operation mode shifts to the pointer mode, (i) in a case where the off-hook key is pressed and held down or (ii) in a case where a specific application is launched. Note that when activated, the mobile phone 10 initially operates in the key operation mode.

The pointer mode is a mode in which a cursor appearing as an arrow mark is displayed on a screen so as to allow a user to carry out, via the touch pad 16, (i) an operation of moving the cursor and (ii) an operation of entering a decision. The pointer mode includes a cursor non-display state and a cursor display state. In the cursor non-display state, a touch and slight swipe made on the touch pad 16 (i.e., the operation surface of the second housing 2) by a user causes the cursor to be displayed, i.e., a shift from the cursor non-display state to the cursor display state. In the cursor display state, a user can (i) move the cursor by swiping or flicking the touch pad 16, (ii) enter a decision at a location where the cursor is displayed, by making a single tap on the touch pad 16 within a given period of time (e.g., 1.5 seconds) after the cursor has been moved, and (iii) enter a decision at a location where the cursor is displayed, by making a double tap on the touch pad 16. The cursor is cleared, i.e., the cursor display state is shifted to the cursor non-display state, in a case where (i) a user presses the hardware keys 15 in the cursor display state or (ii) a user does not operate the touch pad 16 for a given period of time in the cursor display state. Note that in the pointer mode, the mobile phone 10 can be operated also via the hardware keys 15 as in the key operation mode.

The mobile phone 10 in the pointer mode shifts to the key operation mode in a case where (i) the off-hook key is pressed and held down or (ii) the specific application is terminated. The mobile phone 10 in the pointer mode shifts to the scroll mode in a case where a user makes a long tap on the touch pad 16. Note that when the mobile phone 10 shifts to the pointer mode, the mobile phone 10 initially operates in the cursor display state.

The scroll mode is a mode in which the screen is scrollable via the touch pad 16. In the scroll mode, a user can (i) swipe or flick the touch pad 16 so that the screen is scrolled and (ii) make a long tap on the touch pad 16 so that a given process corresponding to an activated application is carried out. The mobile phone 10 in the scroll mode shifts to the pointer mode (i) in a case where a user makes a single tap on the touch pad 16 or (ii) a case where a user does not operate the touch pad 16 for a given period of time. On the other hand, the mobile phone 10 in the scroll mode shifts to the key operation mode in a case where the specific application is terminated.

### Shift from Scroll Mode to Pointer Mode

As described above, in the pointer mode, a user can make operations such as an operation of selecting a displayed object. In contrast, the scroll mode is specialized for a scroll operation, so that in the scroll mode, a user cannot make the operations such as an operation of selecting a displayed object. It follows that, in the scroll mode, a single tap is not assigned to any process such as a process of selecting a displayed object. It is thus possible to assign a single tap to a mode shifting process. When a user intends to make a single tap, a long tap, a scroll operation, or the like that is not intended by the user is less likely to be inputted. Therefore, a user can more securely cause, with a simple operation of making a single tap, the mobile phone 10 to shift from the scroll mode to the pointer mode, as compared with conventional mobile phones.

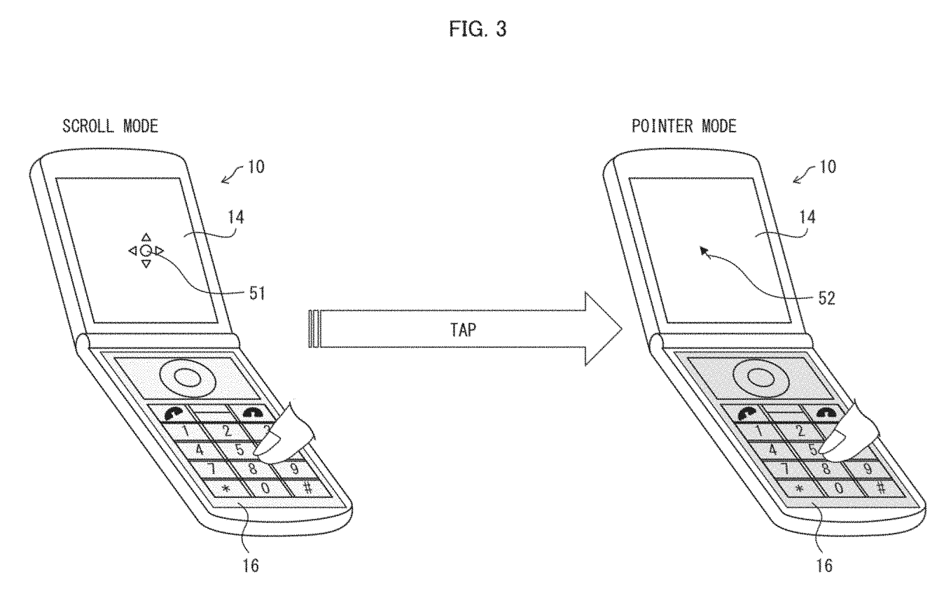

The following description will discuss, with reference to FIG. 3, cursors which are displayed on the display section 14 in the scroll mode and the pointer mode, respectively. FIG. 3 is a view illustrating an appearance of the mobile phone 10 which is shifting from the scroll mode to the pointer mode.

In order for a user to distinguish whether the mobile phone 10 is in the scroll mode or in the pointer mode, the scroll mode and the pointer mode differ from each other in shape of a cursor to be displayed on the display section 14 (see FIG. 3). As illustrated in FIG. 3, a cursor to be displayed in the scroll mode has a shape which combines a single circle, located at a center, with four triangles located around the single circle such that the four triangles are on the left, right, top and bottom of the single circle, respectively. In contrast, a cursor to be displayed in the pointer mode has an arrow shape.

### Configuration of Mobile Phone

The following description will discuss in detail a configuration and a function of the mobile phone 10 with reference to FIG. 1. FIG. 1 is a block diagram illustrating a configuration of a main part of the mobile phone 10 in accordance with Embodiment 1.

The mobile phone 10 includes a central processing unit (CPU) 11, a read only memory (ROM) 12, a random access memory (RAM) 13, the display section 14, the hardware keys 15, and the touch pad 16 (see FIG. 1). Note that the mobile phone 10 can further include a member(s) such as a communication section, a voice input section, and/or a voice output section. Such members, however, are not illustrated in the drawings because they are not related to features of the present invention.

The CPU 11 is configured to (i) carry out various calculations by executing a program which the RAM 13 has read out from the ROM 12 and (ii) comprehensively control sections provided in the mobile phone 10.

The CPU 11 in accordance with Embodiment 1 includes, as its functional blocks, an event identifying section (location information acquiring section) 21, an event delivering section 22, a mode switching section (user's operation identifying section) 23, and an application control section (user's operation identifying section) 24.

The event identifying section 21 receives location information from the touch pad 16, and identifies a touch event based on the location information thus received. The event identifying section 21 then creates event information indicative of the touch event thus identified, and supplies the event information thus created to the event delivering section 22. Note that the event identifying section 21 can also store the event information in the RAM 13.

Specifically, the event identifying section 21 determines a type of a touch event so as to identify the touch event, at detection intervals at which the touch pad 16 detects an object. In a case where the event identifying section 21 did not receive location information from the touch pad 16 in carrying out an immediately previous identification but receives location information (current location information) from the touch pad 16 in carrying out a current identification, the event identifying section 21 determines that a touch down event has occurred at a location indicated by the current location information. In contrast, in a case where the event identifying section 21 received location information (previous location information) from the touch pad 16 in carrying out an immediately previous identification but receives no further location information from the touch pad 16 in carrying out a current identification, the event identifying section 21 determines that a touch up event has occurred at a location indicated by the previous location information. In a case where (i) the event identifying section 21 received location information (previous location information) from the touch pad 16 in carrying out an immediately previous identification and receives further location information (current location information) from the touch pad 16 in carrying out a current identification and (ii) a location indicated by the current location information is identical to a location indicated by the previous location information, the event identifying section 21 determines that a touch down event has occurred at the location indicated by the current location information. In a case where (i) the event identifying section 21 received location information (previous location information) from the touch pad 16 in carrying out an immediately previous identification and receives further location information (current location information) from the touch pad 16 in carrying out a current identification and (ii) a location indicated by the current location information is different from a location indicated by the previous location information, the event identifying section 21 determines that a move event has occurred at the location indicated by the current location information. The event identifying section 21 thus identifies a touch event as a touch up event, a touch down event, or a move event.

In a case where the event identifying section 21 identifies a touch event, it creates event information which contains (i) type information indicative of a type of the touch event (i.e., a touch clown event, a touch up event, or a move event) and (ii) location information of the touch event. Specifically, in a case where the touch event is identified as a touch down event, the event information contains location information indicative of a location at which the touch down event has occurred. In a case where the touch event is identified as a touch up event, the event information contains location information indicative of a location at which the touch up event has occurred (i.e., a location at which an immediately previous touch down event or an immediately previous move event has occurred). In a case where the touch event is identified as a move event, the event information contains location information indicative of a location at which the move event has occurred.

The event delivering section 22 receives event information from the event identifying section 21, and supplies the event information thus received to the mode switching section 23 or to the application control section 24. The event delivering section 22 generally supplies, on a real-time basis, event information received from the event identifying section 21 to the mode switching section 23 or to the application control section 24. Note, however, that at least in the scroll mode, the event delivering section 22 does not output event information on a real-time basis. A process which the event delivering section 22 carries out in the scroll mode will be discussed later.

The following description will discuss how the CPU 11 determines a user's operation carried out on the touch pad 16. Examples of a user's operation to be carried out on the touch pad 16 include a touch, a single tap, a double tap, a long tap, a swipe, and a flick. Embodiment 1 does not particularly distinguish between a swipe and a flick, and a swipe and a flick are therefore collectively referred to as a scroll operation. The CPU 11 (particularly, the event delivering section 22, the mode switching section 23, and the application control section 24) determines a type of a user's operation based on one or more touch events identified by the event identifying section 21.

A touch is a user's operation of bringing an object into contact with the touch pad 16. The CPU 11 determines that a user has made a touch in a case where a touch down event is detected. A single tap is a user's operation of bringing an object into contact with the touch pad 16 and then immediately taking the object off the touch pad 16 without moving the object on the touch pad 16. The CPU 11 determines that a user has made a single tap, in a case where (i) a touch down event is detected and (ii) then a touch up event is detected without detecting a move event involving a move over a given distance or longer, within a given period of time or at the time of a next detection. A double tap is a user's operation of making a single tap two times in succession. The CPU 11 determines that a user has made a double tap in a case where it is determined that a single tap is made two times in succession within a given period of time. A long tap is a user's operation of bringing an object into contact with the touch pad 16 and then, after a given period of time, taking the object off the touch pad 16 without moving the object on the touch pad 16. The CPU 11 determines that a user has made a long tap in a case where (i) a touch down event is detected, (ii) then, further detection of a touch down event continues for a given period of time without detection of a move event involving a move over a given distance or longer and (iii) a touch up event is lastly detected (or in a case where a touch down event is detected for a given period of time without detection of a move event involving a move over a given distance or longer). A scroll operation is a user's operation of bringing an object into contact with the touch pad 16 and then moving, on the touch pad 16, the object kept in contact with the touch pad 16. The CPU 11 determines that a user has carried out a scroll operation in a case where a touch down event is detected and then a move event involving a move over a given distance or longer is detected (or in a case where a move event involving a move over a given distance or longer is detected and then another move event is further detected).

The mode switching section 23 is configured to switch between modes in each of which the mobile phone 10 operates. Specifically, the mode switching section 23 receives event information from the event delivering section 22, and identifies a user's operation based on the event information thus received. The mode switching section 23 then switches one mode to another in accordance with the user's operation thus identified.

The application control section 24 is configured to control an application executable on the mobile phone 10. Specifically, the application control section 24 receives event information from the event delivering section 22, and identifies a user's operation based on the event information thus received. The application control section 24 then carries out, in accordance with the user's operation thus identified, a process that is predetermined for an activated application. The application control section 24 can control any application executable on the mobile phone 10, such as a phone call application, a mail application, an image display application, a video player application, and a document creation application.

The ROM 12 is a storage section configured to store (i) a program which is software to realize each function of the mobile phone 10 and (ii) various data. The ROM 12 stores, for example, a scroll threshold 31 which is used to determine whether a user's operation is a scroll operation.

The RAM 13 is a temporary storage section in which the program is loaded when the CPU 11 executes the program. The RAM 13 stores, for example, event information 41.

### Process Carried Out by Event Delivering Section in Scroll Mode

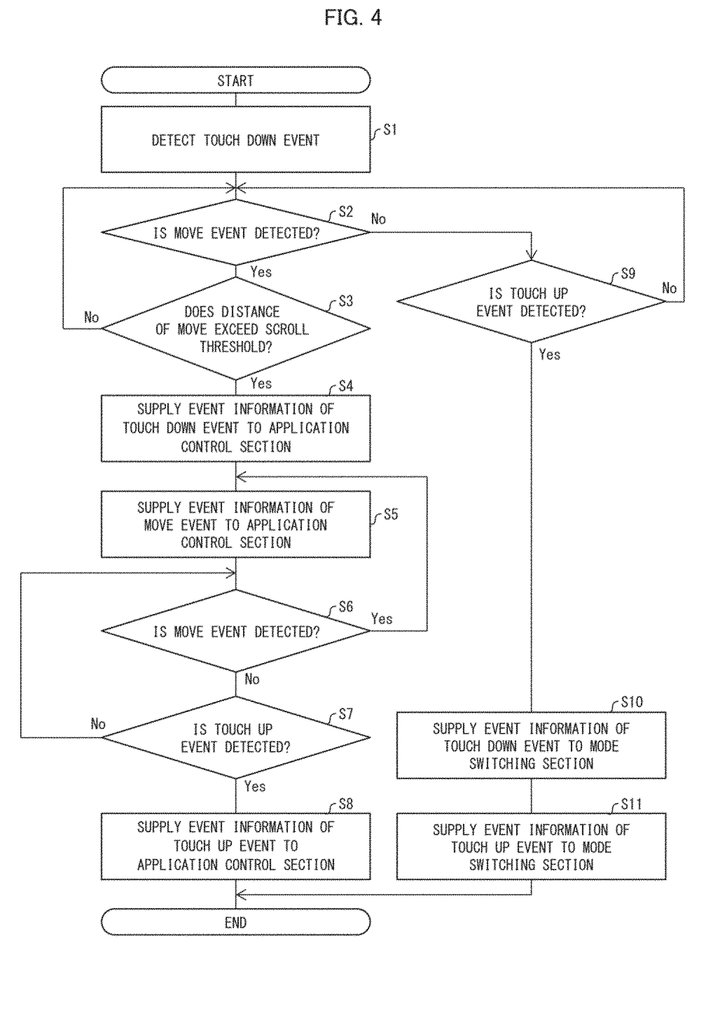

The following description will discuss, with reference to 4, a process which the event delivering section 22 carries out in the scroll mode. FIG. 4 is a flowchart illustrating an example of the process which the event delivering section 22 carries out in the scroll mode.

As illustrated in FIG. 4, in a case where a user makes a touch in the scroll mode, the event delivering section 22 receives, from the event identifying section 21, event information indicative of a touch down event (S1). Note that in conventional techniques, such event information indicative of a touch down event is outputted on a real-time basis. The event delivering section 22, however, does not output the event information thus received but stores the event information in the RAM 13. The event delivering section 22 then waits for another event information (S2).

Receiving, from the event identifying section 21, another event information indicative of a move event (YES in S2), the event delivering section 22 determines whether a distance of a move in the move event exceeds the scroll threshold 31 stored in the ROM 12 (S3). In a case where the distance of the move does not exceed the scroll threshold 31 (NO in S3), the event delivering section 22 waits for yet another event information (S2). In contrast, in a case where the distance of the move exceeds the scroll threshold 31 (YES in S3), the user's operation is a scroll operation (user's operation identifying step). In this case, the event delivering section 22 (i) reads out the event information indicative of the touch down event and stored in the RAM 13 (i.e., event information which contains location information indicative of a location at which the touch down event first occurred), and (ii) supplies the event information thus read out to the application control section 24 (S4). Subsequently, the event delivering section 22 supplies, to the application control section 24, the another event information, indicative of the move event, which is currently received (S5).

After that, the event delivering section 22 waits for yet another event information (S6). In a case where the event delivering section 22 receives, from the event identifying section 21, yet another event information indicative of a move event (YES in S6), the user's operation is a further scroll operation (user's operation identifying step). In this case, the event delivering section 22 supplies, to the application control section 24, the yet another event information and indicative of the move event (S5).

In contrast, in a case where the yet another event information, which the event delivering section 22 received from the event identifying section 21 in the step S6, indicates a touch up event (YES in S7), the event delivering section 22 supplies, to the application control section 24, the yet another event information and indicative of the touch up event (S8).

In a case where the another event information, which the event delivering section 22 received from the event identifying section 21 in the step S2, indicates a touch up event (YES in S9), the user's operation is a single tap (user's operation identifying step). In this case, the event delivering section 22 (i) reads out the first event information stored in the RAM 13 and indicative of the touch down event, and (ii) supplies the event information, indicative of the touch down event, thus read out to the mode switching section 23 (S10). Subsequently, the event delivering section 22 supplies, to the mode switching section 23, the another event information and indicative of the touch up event (S11). As described above, in a case where YES in S9, the event delivering section 22 does not supply, to the application control section 24, the event information received first and indicative of the touch down event.

Note that: in the step S5, the application control section 24, which received pieces of event information respectively indicative of the touch down event and the move event, determines that the user's operation is a scroll operation and scrolls the screen; and in the step S11, the mode switching section 23, which received pieces of event information respectively indicative of the touch down event and the touch up event, determines that the user's operation is a single tap and switches the scroll mode to the pointer mode (mode switching step).

In a typical application, sonic kind of process is associated with a user's touch (a touch in a first touch down event only). It follows that, in a case where a touch event is supplied to an application control section on a real-time basis as with conventional techniques, the application control section carries out some kind of process. In Embodiment 1, the scroll mode is shifted to the pointer mode in response to a single tap. Therefore, in a case where a conventional technique is applied to Embodiment 1, an unnecessary process is executed before mode switching when a user carries out a mode shifting operation (single tap). In Embodiment 1, however, it is unnecessary to supply a touch down event and a touch up event to the application control section 24 until it is determined whether a user's operation is a single tap.

In the scroll mode, the event delivering section 22 therefore holds, in the RAM 13, a touch event which is identified by the event identifying section 21, until it becomes possible to determine at least whether a user's operation is a single tap. The event delivering section 22 then supplies the touch event to the mode switching section 23 or to the application control section 24 when it becomes possible to determine at least whether the user's operation is a single tap. This makes it possible to (i) present the application control section 24 from carrying out a process and (ii) make a touch caused by a single tap invalid, at least until it is determined whether the user's operation is a single tap. The mobile phone 10 can therefore shifts from the scroll mode to the pointer mode without carrying out any unnecessary process.

### Embodiment 2

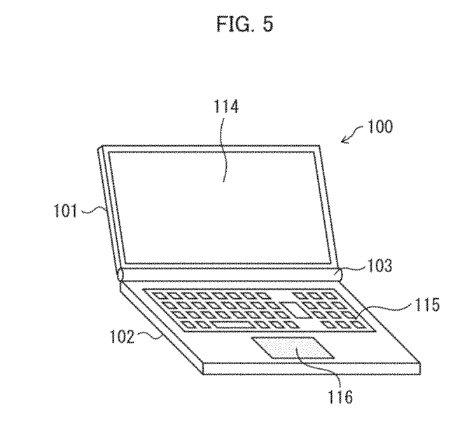

The following description will discuss Embodiment 2 of the present invention with reference to FIGS. 5 through 7. Embodiment 2 is an example in which the present invention is applied to a laptop PC. Note that in Embodiment 2, the definitions of terms that are defined in Embodiment 1 are the same as those in Embodiment 1, respectively, unless particularly stated otherwise.

### Outline of Laptop PC

A laptop PC in accordance with Embodiment 2 will be discussed below with reference to FIG. 5. FIG. 5 is a view illustrating an appearance of a laptop PC 100 in accordance with Embodiment 2.

The laptop PC 100 is a clamshell laptop PC (see FIG. 5). The laptop PC 100 includes a first housing 101 and a second housing 102, which are connected. to each other via a hinge 103 so as to be rotatable about an axis of the hinge 103. Each of the first housing 101 and the second housing 102 has, for example, a substantially-plate-like shape. The first housing 101 is provided with a display section 114 on a surface of the first housing 101. The second housing 102 is provided with hardware keys 115 and a touch pad (object detecting section) 116 on a surface of the second housing 102.

The laptop PC 100 can change in form between (i) an open state in which the first housing 101 and the second housing 102 are open as illustrated in FIG. 5 and (ii) a closed state (not illustrated) in which (a) the surface (display surface) of the first housing 101, on which surface the display section 114 is provided, and (b) the surface (operation surface) of the second housing 102, on which surface the hardware keys 115 and the touch pad 116 are provided, face each other.

The display section 114 is configured to display an image. The display section 114 can be, for example, a liquid crystal display (LCD) or an organic EL display.

The hardware keys 115 allow a user to operate the laptop PC 100. The hardware keys 115 are physical keys configured to output a signal corresponding to a key which the user has pressed. The hardware keys 15 are made up of, for example, keys which are employed in a typical laptop PC.

The touch pad 116 is used to operate the laptop PC 100. The touch pad 116 includes a sensor so as to detect an object (e.g., a user's finger or a stylus) in proximity to or in contact with the touch pad 116. The touch pad 116 outputs location information indicative of a location (e.g., two-dimensional coordinates on the touch pad 116) at which the object has been detected. In Embodiment 2, the touch pad 116 detects an object in a detection region (detection surface), which serves as a part of the operation surface of the second housing 2, and top surfaces of the respective hardware keys 15 are not within the detection region. That is, the touch pad 116 is provided on the operation surface of the second housing 2 at a location where the hardware keys 115 are not provided. The sensor included in the touch pad 116 is, for example, a capacitance sensor.

In Embodiment 2, the touch pad 116 detects whether a user's finger is in contact with the touch pad 116. As with Embodiment 1, the detection surface (detection region) of the touch pad 116 is provided at a location outside a display surface (display region) of the display section 114 (see FIG. 5).

The laptop PC 100 in accordance with Embodiment 2 also operates in three modes, i.e., in a “key operation mode”, a “pointer mode”, and a “scroll mode”, and operates as with the mobile phone 10 in accordance with Embodiment 1.

### Configuration and Function of Laptop PC

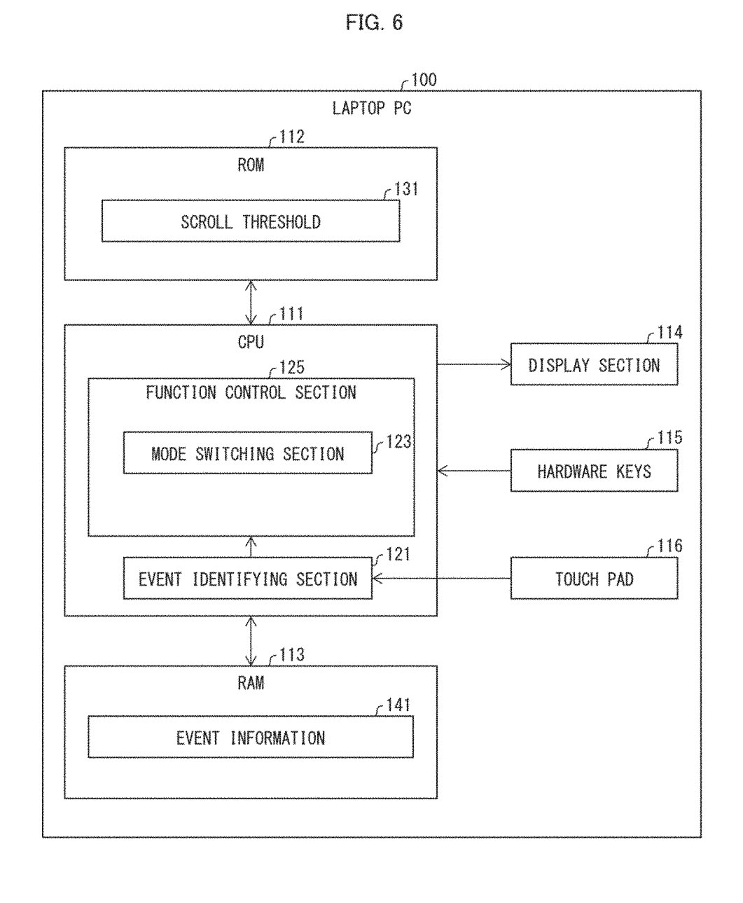

The following description will discuss a configuration and a function of the laptop PC 100 with reference to FIG. 6. FIG. 6 is a block diagram illustrating a configuration of a main part of the laptop PC 100 in accordance with Embodiment 2.

The laptop PC 100 includes a CPU 111, a ROM 112, a RAM 113, the display section 114, the hardware keys 115, and the touch pad 116 (see FIG. 6). Note that the laptop PC 100 can further include a member(s) such as a communication section, a voice input section, and/or a voice output section. Such members, however, are not illustrated in the drawings because they are not related to features of the present invention.

The CPU 111 is configured to (i) carry out various calculations by executing a program which the RAM 113 has read out from the ROM 112 and (ii) comprehensively control sections provided in the laptop PC 100.

The CPU 111 in accordance with Embodiment 2 includes, as its functional blocks, an event identifying section (location information acquiring section) 121 and a function control section (user's operation identifying section) 125. The function control section 125 includes a mode switching section 123. The event identifying section 121 and the mode switching section 123 are respectively identical in function to the event identifying section 21 and the mode switching section 23 of the mobile phone 10 in accordance with Embodiment 1, and therefore their descriptions are omitted.

The function control section 125 is configured to execute a function of the laptop PC 100. Specifically, the function control section 125 receives event information from the event identifying section 121, and identifies a user's operation based on the event information thus received. The function control section 125 then carries out a process corresponding to the user's operation thus identified.

The ROM 112 and the RAM 113 are respectively identical in function to the ROM 12 and the RAM 13 of the mobile phone 10 in accordance with Embodiment 1, and therefore their descriptions are omitted.

### Process Carried Out by CPU in Scroll Mode

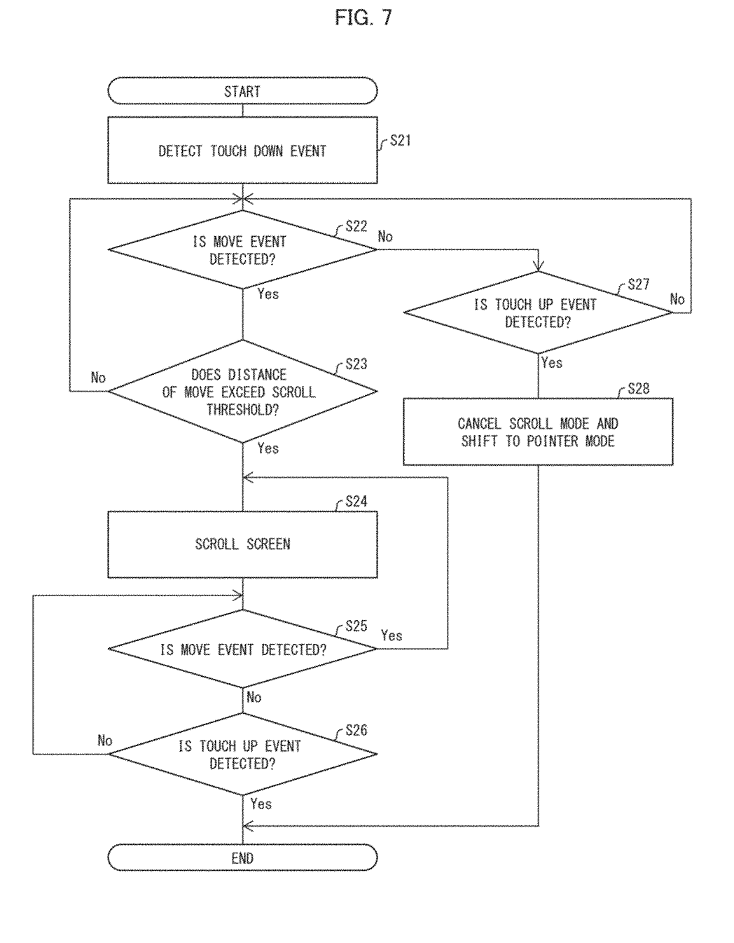

The laptop PC 100 in accordance with Embodiment 2 differs in process to be carried out in the scroll mode from the mobile phone 10 in accordance with Embodiment 1. The following description will discuss the process with reference to FIG. 7. FIG. 7 is a flowchart illustrating an example of a process to be carried out while the laptop PC 100 in accordance with Embodiment 2 is in the scroll mode.

As illustrated in FIG. 7, in a case where a user makes a touch in the scroll mode, the event identifying section 121 identifies a touch down event based on location information received from the touch pad 116 (S21). The event identifying section 121 then supplies, to the function control section 125, the event information indicative of the touch down event thus identified. Based on the event information thus received, the function control section 125 determines that the user has inputted a touch (user's operation identifying step). Note here that the function control section 125 carries out no particular process because no process is assigned to a touch. The event identifying section 121 then waits for another user's operation (S22).

Subsequently, in a case where the user carries out a scroll operation, the event identifying section 121 identifies a move event based on another location information received from the touch pad 116 (YES in S22). The event identifying section 121 then supplies, to the function control section 125, the another event information indicative of the move event thus identified. The function control section 125 determines whether a distance of a move of the move event indicated by the another event information, indicative of the move event, exceeds a scroll threshold 131 stored in the ROM 112 (S23). In a case where the distance of the move does not exceed the scroll threshold 131 (NO in S23), the function control section 125 carries out no particular process, and the event identifying section 121 waits for another user's operation (S22). In contrast, in a case where the distance of the move exceeds the scroll threshold 131 (YES in S23), the function control section 125 determines that the user has inputted a scroll operation (user's operation identifying step), and scrolls a screen in accordance with the scroll operation (S24). The event identifying section 121 then waits for another user's operation (S25).

In a case where the user continuously carries out the scroll operation, the event identifying section 121 identifies a move event (YES in S25). The function control section 125 then determines that the user has inputted a further scroll operation (user's operation identifying step), and scrolls the screen in accordance with the further scroll operation (S24). The event identifying section 121 then waits for another user's operation (S25).

In a case where the user takes an object off the touch pad 116 in the step S25, location information is no longer supplied from the touch pad 116 to the event identifying section 121, and the event identifying section 121 therefore identifies a touch up event (YES in S26). The event identifying section 121 then supplies, to the function control section 125, yet another event information indicative of the touch up event thus identified. Based on the yet another event information thus received, the function control section 125 determines that the user has finished the scroll operation (user's operation identifying step), and ends the scroll operation.

In contrast, in a case where the user makes a touch and then immediately takes the object off the touch pad 116 in the step S22, the touch pad 116 stops supplying location information to the event identifying section 121. The event identifying section 121 therefore identifies a touch up event (YES in S27). The event identifying section 121 then supplies, to the function control section 125, another event information indicative of the touch up event thus identified. Based on the another event information thus received, the function control section 125 determines that the user has inputted a single tap (user's operation identifying step), and instructs the mode switching section 123 to switch between modes. In response to the instruction, the mode switching section 123 switches the scroll mode to the pointer mode (S28: mode switching step).

### Software Implementation Example

Control blocks of each of the mobile phone 10 and the laptop PC 100 (the event identifying section 21, the event delivering section 22, the mode switching section 23, the application control section 24, the event identifying section 121, the mode switching section 123, and the function control section 125) can be realized by a logic circuit (hardware) provided in an integrated circuit (IC chip) or the like or can be alternatively realized by software with use of a CPU as with the foregoing embodiments.

In the latter case, the mobile phone 10 or the laptop PC 100 includes, as with the foregoing embodiments, a CPU that executes instructions of a program that is software realizing the foregoing functions; a ROM or a storage device (each referred to as “storage medium”) in which the program and various kinds of data are stored so as to be readable by a computer (or a CPU); and a RAM that develops the program in executable form. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

### Main Points

An information processing device in accordance with a first aspect of the present invention includes: a display section; an object detecting section having, at a location outside a display region of the display section, a planar detection region in which the object detecting section detects an object in proximity to or in contact with the detection region; a location information acquiring section configured to acquire location information indicative of a location where the object detecting section has detected the object; a user's operation identifying section configured to identify a type of a user's operation based on the location information which the location information acquiring section has acquired; and a mode switching section configured to switch a scroll mode, in which a screen is scrollable, to a pointer mode, in which a displayed object is selectable, in a case where the user's operation identifying section identifies a single tap in the scroll mode.

The above configuration makes it possible to cause a shift from the scroll mode to the pointer mode with a simple operation of making a single tap.

The information processing device in accordance with a second aspect of the present invention can be configured to such that, in the first aspect of the present invention, the location information acquiring section identifies a type of a touch event based on the location information, the information processing device further including an event delivering section configured to supply, to the user's operation identifying section, a touch event identified by the location information acquiring section, the event delivering section holding the touch event until it becomes possible to determine at least whether the user's operation is a single tap.

For example, in a case where the location information acquiring section identifies a touch down event, the user's operation identifying section determines that a user has made a touch. Subsequently, in a case where the location information acquiring section which has identified the touch down event further identifies a touch up event without identifying a move event involving a move over a given distance or longer, the user's operation identifying section determines that the user has made a single tap. That is, the single tap inevitably includes a touch. It follows that, in a case where (i) some kind of process is assigned to a touch and (ii) a touch event is outputted on a real-time basis in the scroll mode, a process which is assigned to a touch to be made in the scroll mode is carried out despite the fact that the user is making a single tap so as to cause a shift from the scroll mode to the pointer mode.

However, according to the above configuration, the event delivering section does not output the touch event which the location information acquiring section has identified, until it becomes possible to determine at least whether a user's operation is a single tap. It is therefore possible to prevent a touch contained in a single tap from being erroneously determined as a user's operation.

The information processing device in accordance with a third aspect of the present invention can be configured such that, in the second aspect of the present invention, the event delivering section supplies the touch event to the user's operation identifying section when it becomes possible to determine at least whether the user's operation is a single tap.

The above configuration makes it possible to (i) prevent a touch contained in a single tap from being erroneously determined as a user's operation and (ii) correctly determine a user's operation other than the touch contained in the single tap.

A method of controlling an information processing device in accordance with a fourth aspect of the present invention is a method of controlling an information processing device which includes a display section, an object detecting section having, at a location outside a display region of the display section, a planar detection region in which the object detecting section detects an object in proximity to or in contact with the detection region, and a location information acquiring section configured to acquire location information indicative of a location where the object detecting section has detected the object, the method including the steps of: (a) identifying a type of a user's operation based on the location information which the location information acquiring section has acquired; and (b) switching a scroll mode, in which a screen is scrollable, to a pointer mode, in which a displayed object is selectable, in a case where a single tap is identified in the step (a) in the scroll mode.

The above configuration brings about an effect similar to that brought about by the information processing device.

The information processing device in accordance with each aspect of the present invention can be realized by a computer. In this case, the scope of the present invention encompasses: a control program for causing a computer to operate as each section (software element) of the information processing device so that the information processing device can be realized by the computer; and a computer-readable recording medium in which the control program is recorded.

The present invention is not limited to the foregoing embodiments, but can be altered by a skilled person in the art within the scope of the claims. The present invention also encompasses, in its technical scope, any embodiment derived by combining technical means disclosed in different embodiments. Further, it is possible to form a new technical feature by combining the technical means disclosed in the respective embodiments.

### INDUSTRIAL APPLICABILITY

The present invention is applicable to an information processing device such as a mobile phone, a laptop PC, a portable game device, a digital camera, a digital video camera, and a portable music player.

### Reference Signs list

10: Mobile phone (information processing device)

14, 114: Display section

16, 116: Touch pad (object detecting section)

21, 121: Event identifying section (location information acquiring section)

22: Event delivering section

23, 123: Mode switching section (user's operation identifying section)

24: Application control section (user's operation identifying section)

100: Laptop PC (information processing device)

125: Function control section (user's operation identifying section)

1-5. (canceled)

6. An information processing device, comprising:
a display section;
an object detecting section having, at a location outside a display region of the display section, a detection region in which the object detecting section detects an object in proximity to or in contact with the detection region; and
a control section configured to identify at least one touch event based on a detection result received from the object detecting section,
the information processing device having (a) a scroll mode in which scrolling of a screen displayed in the display region is executed but selection of a displayed object in the screen is not executed and (b) a pointer mode in which selection of the displayed object is executed,
in a case here (i) the information processing device is in the scroll mode and (ii) the control section identifies a series of touch events which are caused by a single tap, the control section switching the scroll mode to the pointer mode.

7. An information processing device, comprising:
a display section;
an object detecting section having, at a location outside a display region of the display section, a detection region in which the object detecting section detects an object in proximity to or in contact with the detection region; and
a control section configured to identify at least one touch event based on a detection result received from the object detecting section,
the information processing device having (a) a scroll mode in which scrolling of a screen displayed in the display region is executed but selection of a displayed object in the screen is not executed and (b) a pointer mode in which selection of the displayed object is executed,
in a case where (i) the information processing device is in the scroll mode and (ii) the control section determines based on the touch event that a single tap has been made, the control section switching the scroll mode to the pointer mode.

8. The information processing device as set forth in claim 2, wherein:
the control section determines that a single tap is made in a case where the control section identifies one of the at least one touch event as a touch down event and then identifies another one of the at least one touch event as a touch up event without identification of a move event between the touch down event and the touch up event.

9. The information processing device as set forth in claim 3, wherein:
the control section determines that a single tap is made in a case where the control section identifies one of the at least one touch events as a touch down event and then identifies another one of the at least one touch events as a touch up event without identification of a move event involving a move over a given distance or longer between the touch down event and the touch up event.

10. The information processing device as set forth in claim 2, wherein:
in a case where (i) the information processing device is in the scroll mode and (ii) the control section identifies the touch event, the control section acquires location information indicative of a location at which the touch down event has occurred, and uses the location information in scrolling the screen.

11. The information processing device as set forth in claim 1, wherein:
the control section executes scrolling of the screen in a case where (i) the information processing device is in the scroll mode and (ii) the control section identities the touch event as a move event.

12. The information processing device as set forth in claim 1, wherein:
the control section switches the pointer mode to the scroll mode in a case where (i) the information processing device is in the pointer mode and (ii) the control section identifies a series of touch events which are caused by a long tap.

13. The information processing device as set forth in claim 1, wherein:
the control section causes the display section to display a cursor which indicates that the information processing device is in the pointer mode, upon detection of a touch up event which is caused by a single tap intended for switching the scroll mode to the pointer mode.

14. A method of controlling an information processing device which includes a display section and an object detecting section having, at a location outside a display region of the display section, a detection region in which the object detecting section detects an object in proximity to or in contact with the detection region,
the method comprising the steps of:
(a) identifying at least one touch event based on a detection result of the object detecting section; and
(b) switching a scroll mode to a pointer mode in a case where (i) the information processing device is in the scroll mode and (ii) a series of touch events which are caused by a single tap is detected in the step (a),
the scroll mode being a mode in which scrolling of a screen displayed in the display region is executed but selection of a displayed object in the screen is not executed
the pointer mode being a mode in which selection of the displayed object is executed.
